(19) United States
(12) Patent Application Publication
(10) Pub. No.: US 2024/0226927 A1
(43) Pub. Date: Jul. 11, 2024

(54) TAYLOR CONE EMITTER DEVICE RESPOSITORY, TAYLOR CONE EMITTER DEVICE RESPOSITORY SYSTEM, AND METHOD FOR ANALYZING A POPULATION OF SAMPLES

(71) Applicant: RESTEK CORPORATION, Bellefonte, PA (US)

(72) Inventors: Shane C. STEVENS, State College, PA (US); Ryan D. Micklitsch, Jersey Shore, PA (US); German A. Gomez-Rios, San Jose, CA (US); Tracey A. PETERS, Bellefonte, PA (US); Thomas E. Kane, Bellefonte, PA (US)

(21) Appl. No.: 18/558,405

(22) PCT Filed: May 3, 2022
(86) PCT No.: PCT/US2022/027385

§ 371 Date: Nov. 1, 2023

Related U.S. Application Data
(60) Provisional application No. 63/183,240, filed on May 3, 2021.
(60) Provisional application No. 63/183,281, filed on May 3, 2021.

(51) Int. Cl. B05B 5/025; B01L 3/00; B01L 9/00; H01J 49/16

(52) U.S. Cl. CPC B05B 5/025; B01L 3/5085; B01L 9/523; B01L 2200/025; B01L 2300/0829; H01J 49/165

(57) ABSTRACT

A Taylor cone emitter device repository is disclosed including a repository plate, a repository wall extending therefrom, and an array of orifices and an array of clocking feature interfaces disposed therein. The array of orifices receives and retains an array of Taylor cone emitter devices. The array of clocking feature interfaces guide clocking features of the array of Taylor cone emitter devices into predetermined radial orientations. The repository wall peripherally surrounds a substrate chamber configured to receive a microtiter array tray with the array of solid phase microextraction devices each disposed within a separate well of the microtiter array tray. A Taylor cone emitter device repository system is disclosed including the microtiter array tray, the array of Taylor cone emitter devices, and the Taylor cone emitter device repository system. A method for analyzing a population of samples with the Taylor cone emitter device repository system is disclosed.

### RELATED APPLICATIONS

This application claims the benefit of and priority to U.S. Provisional Patent Application No. 63/183,240, filed May 3, 2021, entitled “A Container-Multiwell Plate Assembly for Housing Solid Phase Microextraction Devices,” and U.S. Provisional Patent Application No. 63/183,281, filed May 3, 2021, entitled “Apparatus and Method for Analyzing a Sample,” which are hereby incorporated by reference in their entirety.

### FIELD OF THE INVENTION

This application is directed to Taylor cone emitter device repositories, Taylor cone emitter device repository systems, and methods for analyzing a population of samples with Taylor cone emitter device repository systems. In particular, this application is directed to Taylor cone emitter device repositories, Taylor cone emitter device repository systems, and methods for analyzing a population of samples with Taylor cone emitter device repository systems in which the Taylor cone emitter device repositories receive an array of Taylor cone emitter devices distributed for interface with a microtiter array tray.

### BACKGROUND OF THE INVENTION

### Taylor Cone Emitter Devices

Taylor cone emitter devices are devices capable of creating a Taylor cone in the presence of a liquid and under the influence of an electric field. The Taylor cone may contain the chemical analyte species of interest. Taylor cone emitter devices include electrospray needles, coated blade spray devices (described below), paper spray devices, sorbent coated electrodes, SPME tips, and porous formed probes, among others.

“Electrical surface charges” are charges generated on a surface when a voltage is applied to the emitter or conductor. Surface charge concentrates at regions with the highest curvature. Therefore, a sharp edge or pointed tip may be used to increase the local charge density. The electric field on the metal surface results from the surface charge and is perpendicular to the surface, and its strength is proportional to the surface charge density. The electric field gradient is the rate at which the electric field falls off, and it is strongest on such edges and lines and points. Regions of high electric field gradient are most likely to generate Taylor cones from applied solvent.

Preferably, the Taylor cone is localized in a specific region of the emitter, typically where the cone released from the emitter is positioned to facilitate collection of ionized particles generated from the cone into a mass spectrometer or other ionized particle analyzer.

Taylor cone emitters comprise a shape capable of producing a region of high electric field gradient to create a Taylor cone.

To localize Taylor cones, the emitter device shapes may include, but do not necessarily have, regions having a small radius of curvature, such as sharp points or edges. Localized electric fields are also achieved with protrusions having thin cross sections, narrow diameters, or high aspect ratios as in the case of rods or cones.

Taylor cone emitters may be produced from a single material (substrate) or more than one material in the form of layers or coatings where at least a portion of the uppermost surface serves to collect and release analyte compounds.

Suitable analyte collection materials may collect chemical analytes from a bulk sample. The collection mechanism may be adsorption, dissolution, absorption, or specific binding (e.g., antigen-antibody binding, pore shape and size selection such as metal organic frameworks).

The native uppermost surface of the emitter may serve as an analyte collection material, or analyte collection material may be applied to the uppermost surface. Known applied materials include sorbent beds created with particles and irregular or conformal contiguous coatings. The analyte collection material may be porous or nonporous. The collection material may be permeable or nonpermeable. Typically, the collection material is chemically compatible with the sample and the solvent employed to product the Taylor cone.

### Coated Blade Devices

Coated Blade Spray (“CBS”) is a solid phase microextraction (“SPME”)-based analytical technology previously described in the literature (Pawliszyn et al.; U.S. Pat. No. 9,733,234) that facilitates collection of analytes of interest from a sample and the subsequent direct interface to mass spectrometry systems via a substrate spray event (i.e., electrospray ionization). Solid phase microextraction devices are a form of Taylor cone emitter device typically characterized by having a substrate suitable for retaining a sample. CBS devices typically have regions having a small radius of curvature, such as sharp points or edges.

“Coated blade spray,” “CBS blade'”, and “blade device” are used synonymously herein.

There are two basic stages to CBS-based chemical analysis: (1) analyte collection followed by (2) instrumental analysis. Analyte collection is performed by immersing the sorbent-coated end of the blade device directly into the sample. For liquid samples, the extraction step is generally performed with the sample contained in a vial or well plate.

After analyte collection, the blade device is removed from the sample, and, following a series of rinsing steps, the blade device is then presented to the inlet of the mass spectrometer (MS) for analysis. In this fashion, the blade device undergoes several transfer steps. Reliable positioning of the blade device for each of these steps is therefore important, both for manual and robotic automation handling circumstances.

As a direct to MS chemical analysis device, the blade device requires a pre-wetting of the extraction material so as to release the collected analytes and facilitate the electrospray ionization process (formation of a Taylor cone). Subsequently, a differential potential is applied between the non-coated area of the substrate and the inlet of the MS system, generating an electrospray at the tip of the CBS device. The electric field between the blade and the MS system must be reproducibly created in order to ensure reliable run-to-run precision. Proper positioning of the blade device with respect to the MS skimmer cone opening is therefore very important, including the radial (or rotational) orientation of the blade device.

In general, the blade portion of a blade device has two sides, an upper and a lower. In some cases, different sorbent coatings may be present on each of the flat sides of the blade, and two sample analyses may be therefore performed in sequence: first the analysis of the upper side, followed by a second analysis of the lower. In other examples, same sorbent coating may be present on each of the flat sides of the blade, and a two sample analyses may be therefore performed in sequence, but in different instruments: first the analysis of the upper side on instrument A, followed by a second analysis of the lower on instrument B. In either case, the radial orientation of the blade is also critical.

Previous disclosures describe manually handling the individual blade devices to properly position them with respect to the entrance to the mass spectrometer. Other examples describe one- and two-dimensional arrays of blade devices in a bulk holder. These embodiments include a rigid support capable of housing more than one blade device. Examples of this arrangement include U.S. Pat. No. 7,259,019. These examples are generally aligned to the standard laboratory sampling plasticware, most commonly microtiter array trays having an 8×12 well arrangements, the wells having approximately 9 mm centers. Higher density trays are also commercially available, having smaller sample wells positioned even closer together in order to maintain the standard sample tray footprint.

Because of the single inlet to the MS device, the sample analysis stage is still a serial process when using these array-based designs. A selected blade device within the greater array is positioned for electrospray ionization. This design has the disadvantage of also positioning the entire array of blade devices in the general proximity of the MS, which creates considerable risk of electrical and/or chemical cross talk between adjacent blade devices during the electrospray ionization processes. This in turn particularly undermines chain-of-custody sample analysis applications, such as clinical or forensic screening of biological fluids.

PCT Application PCT/US2020/047201, incorporated herein by references and which entered the national phase in the U.S. and published as U.S. Patent Application No. 2021/0055192, advanced the state of the art by disclosing CBS devices where the close position array arrangement is maintained during the sample extraction processes using standard microtiter array trays, and where individual blade devices are introduced to the ionization region of the mass spectrometer, along with maintaining radial positioning of the blade during the entire sampling-to-analysis process.

### Description of a Micro Pipettor Device

A common tool in laboratories for transporting accurate volumes of liquid is a micropipettor. Examples of this arrangement include U.S. Pat. Nos. 4,284,604, 5,650,124, and 7,421,913. Micropipettors employ a variety of mechanisms to pull liquid volumes into the device and subsequently dispense the liquid. Precision volume capacities for standard pipettors range from 0.1 μL to 10 mL. In order to reduce the risk of sample contamination, disposable pipette tips are employed. The micropipette tips are mounted onto the pipettor by pushing the pipettor into the tip, and friction maintains the tip in place. After the liquid has been dispensed, the tip is ejected off the end of the pipettor, and the entire process is repeated.

In cases where many liquid transfer steps are performed for highly parallel processes, micropipettor devices employing more than one liquid dispensing channel are available. Examples of this arrangement include U.S. Pat. No. 5,021,217. These devices still employ the friction fit attachment mechanism of the disposable tips.

For clarity, the terms “pipette,” “pipettor,” “micropipettor,” and “multichannel pipettor” are used herein synonymously. The terms “pipette tip” and “micropipette tip” are also used synonymously.

Equivalent liquid volumes are drawn and delivered for each tip. Tip position in the pipettor array aligns with the tip positions in storage racks for ease of installation.

Multichannel pipette devices are used with pipette tips in 1- and 2-dimensional array storage racks, so a row of disposable tips can be mounted in parallel into the micropipettor.

Micropipettor technology has also been adapted to robotic systems, where the entire liquid transfer sequence is the same as employed for the manual units but is automated.

Because of the ubiquitous presence of micropipettors in laboratories, both for manual use and integrated into robotic automation setups, maintaining compatibility with the CBS device to the physical dimensions of micropipettor technology is advantageous.

### Micropipette Tips

Because many applications that employ micropipettors are sensitive to chemical contamination, disposable, single use pipette tips are available. Standard micropipette tips are loaded onto the pipettor device by centering the device over the docked tip and tapping the device gently onto the opening of the tip. The tip is mounted via friction and is ready for use. Following use, the dirty microtiter tip is removed from the device by means of a tip ejector, typically a slidable sheath around the shaft of the device that engages with the upper lip of the disposable tip and pushes to overcome the friction connection. An example of a pipette tip that has been modified for sample extraction includes U.S. Pat. No. 7,595,026.

Common micropipette tips are conical and do not have a radial orientation requirement for normal operation.

Conductive tips are used to prevent carryover in automated pipetting robots. An example of a conductive tip is the addition of graphite to the raw material polypropylene which makes the pipette tips electrically conductive and gives the tips an opaque black appearance. Alternative embodiments where a portion of the pipette tip is conductive are described in U.S. Pat. No. 9,346,045. The relative position of the tips within robotic workstations is identified by measuring electric capacitance. The filling level of the liquid in the tip can be determined in sample and reagent containers by measuring electric currents, so that the depth of immersion of the tip can be adjusted to the filling level.

Because of the frequent tip replacement in standard sampling handling practices, multiple tips are stored in racks where the tips are protected from environmental contamination. In keeping with the array position standards described earlier, bulk storage of disposable tips commonly employs the 8×12, 96 tip arrays or multiples of 96 tips with the standard tip center-to-center position. This allows for direct loading into multichannel pipette devices and maintains the standard rack footprint in laboratories and on the automation workstation platforms.

Rack containers for housing micropipette tips do not include elements to maintain the radial orientations of the standard pipette tips.

### Microtiter Array Trays

Industry standard microtiter array trays (also referred to as “microtiter plates,” “microplates,” “microwell plates,” and “multiwells”) are formed according to ANSI SLAS 1-2004 (R2012), “Microplate Footprint Dimensions,” ANSI SLAS 2-2004 (R2012), “Microplate Height Dimensions,” ANSI SLAS 3-2004 (R2012), “Microplate Bottom Outside Flange Dimensions,” ANSI SLAS 4-2004 (R2012), “Microplate Well Positions,” and ANSI SLAS 6-2012, “Microplate Well Bottom Elevation.” Microtiter array trays are often docked or otherwise engaged with laboratory equipment, whereby the wells are accessed by automation. Common automation processes accessing microtiter wells include liquid dispensing. In many automation systems, multiple microtiter array trays are docked, requiring precise knowledge of the well positions with respect to each other as well as to neighboring microtiter array trays. The microtiter array tray has standardized values for tray length and tray width. Microtiter array trays may optionally have a tray wall recessed from the tray skirt. Industry standard dimensions are 127.71 mm length by 85.43 mm width by 14.10 mm height. Microtiter array trays commonly comprise 6 (2×3), 12 (3×4, 24 (4×6), 48 (6×8), 96 (8×12), or 384 (16×24) wells of varying volume, as well as other arrays described in the standards. The volume is determined by the number, size and depth of the wells. The tray footprints of these microtiter trays are specified in the related ANSI standards.

### BRIEF DESCRIPTION OF THE INVENTION

In one exemplary embodiment, a Taylor cone emitter device repository includes a repository plate, a repository wall extending from the repository plate, an array of orifices disposed in the repository plate, and an array of clocking feature interfaces disposed in the repository plate. The repository wall extends from the repository plate and peripherally surrounds a substrate chamber. Each of the array of orifices is configured to receive and retain a substrate and a receptacle mount of one of an array of Taylor cone emitter devices. The array of clocking feature interfaces is configured to guide clocking features of each of the array of Taylor cone emitter devices into predetermined radial orientations such that the array of clocking feature interfaces fixes each of the array of Taylor cone emitter devices in the predetermined radial orientations. The substrate chamber is configured to at least partially receive a microtiter array tray and to accept the substrate of each of the array of Taylor cone emitter devices with the substrate and a tapering tip extending from the substrate being remote from contact with the repository wall or any adjacent of the array of Taylor cone emitter devices disposed in the Taylor cone emitter device repository. The array of orifices disposed in the repository plate is distributed in alignment with the microtiter array tray such that each of the array of Taylor cone emitter devices, when the microtiter array tray is at least partially received by the substrate chamber, is disposed within a separate well of the microtiter array tray.

In another exemplary embodiment, a Taylor cone emitter device repository system includes a microtiter array tray having an array of wells, an array of Taylor cone emitter devices, and a Taylor cone emitter device repository. Each of the array of Taylor cone emitter devices includes a substrate having at least one planar surface, a sorbent layer disposed on at least a portion of the at least one planar surface, a tapering tip extending from the substrate, a receptacle mount configured for removable attachment to an emplacement of a receiving device, and a clocking feature configured for fixing a radial orientation of the planar surface with respect to the receiving device. The Taylor cone emitter device repository includes a repository plate, a repository wall extending from the repository plate, an array of orifices disposed in the repository plate, and an array of clocking feature interfaces disposed in the repository plate. The repository wall peripherally surrounds a substrate chamber. Each of the array of orifices is configured to receive and retain the substrate and the receptacle mount of one of the array of Taylor cone emitter devices. The array of clocking feature interfaces is configured to guide clocking features of each of the array of Taylor cone emitter devices into predetermined radial orientations such that the array of clocking feature interfaces fixes each of the array of Taylor cone emitter devices in the predetermined radial orientations. The substrate chamber is configured to at least partially receive the microtiter array tray and to accept the substrate of each of the array of Taylor cone emitter devices with the substrate and the tapering tip being remote from contact with the repository wall or any adjacent of the array of Taylor cone emitter devices disposed in the Taylor cone emitter device repository. The array of orifices disposed in the repository plate is distributed in alignment with the microtiter array tray such that each of the array of Taylor cone emitter devices, when the microtiter array tray is at least partially received by the substrate chamber, is disposed within a separate well of the array of wells.

In another exemplary embodiment, a method for analyzing a population of samples includes disposing a plurality of sample-exposed Taylor cone emitter devices in a Taylor cone emitter device repository as an array of Taylor cone emitter devices. Each of the array of Taylor cone emitter devices includes a substrate having at least one planar surface, a sorbent layer disposed on at least a portion of the at least one planar surface, a tapering tip extending from the substrate, a receptacle mount configured for removable attachment to an emplacement of a receiving device, and a clocking feature configured for fixing a radial orientation of the planar surface with respect to the receiving device. The Taylor cone emitter device repository includes a repository plate, a repository wall extending from the repository plate, an array of orifices disposed in the repository plate, and an array of clocking feature interfaces disposed in the repository plate. The repository wall peripherally surrounds a substrate chamber. Each of the array of orifices is configured to receive and retain a substrate and a receptacle mount of one of an array of Taylor cone emitter devices. The array of clocking feature interfaces is configured to guide clocking features of each of the array of Taylor cone emitter devices into predetermined radial orientations such that the array of clocking feature interfaces fixes each of the array of Taylor cone emitter devices in the predetermined radial orientations. The substrate chamber is configured to at least partially receive a microtiter array tray and to accept the substrate of each of the array of Taylor cone emitter devices with the substrate and a tapering tip extending from the substrate being remote from contact with the repository wall or any adjacent of the array of Taylor cone emitter devices disposed in the Taylor cone emitter device repository. The array of orifices disposed in the repository plate is distributed in alignment with the microtiter array tray such that each of the array of Taylor cone emitter devices, when the microtiter array tray is at least partially received by the substrate chamber, is disposed within a separate well of an array of wells of the microtiter array tray. The method further includes at least partially disposing a first microtiter array tray in the substrate chamber, preparing the array of Taylor cone emitter devices for analysis in the Taylor cone emitter device repository, withdrawing each of the array of Taylor cone emitter devices from the Taylor cone emitter device repository and analyzing each the array of Taylor cone emitter devices by a first analytical method to screen for a predetermined sample characteristic, sorting the array of Taylor cone emitter devices based on the predetermined sample characteristic, forming a consolidated array of Taylor cone emitter devices, and performing a second analytical method on the consolidated array of Taylor cone emitter devices.

### BRIEF DESCRIPTION OF THE DRAWINGS

FIG. 1 illustrates an industry standard microtiter array tray.

FIGS. 2(a)-(c) illustrate a Taylor cone emitter device having fin elements for control of radial orientation while housed in a storage container from a side view (FIG. 2(a)), a front view (FIG. 2(b)), and a perspective view (FIG. 2(c)), according to an embodiment of the present disclosure.

FIGS. 3(a)-(b) illustrate a Taylor cone emitter device repository with three examples of mechanical elements to promote control of the radial orientation of a Taylor cone emitter device having fin elements from a top view (FIG. 3(a)) and a side view (FIG. 3(b)).

FIG. 4 illustrates an example of a Taylor cone emitter device repository with three exemplary properly docked Taylor cone emitter devices having fin elements.

FIGS. 5(a)-(b) illustrate a first exemplary Taylor cone emitter device repository system in an exploded view (FIG. 5(a)) and an assembled view (FIG. 5(b)), according to an embodiment of the present disclosure.

FIGS. 6(a)-(b) illustrate a second exemplary Taylor cone emitter device repository system in an exploded view (FIG. 6(a)) and an assembled view (FIG. 6(b)), according to an embodiment of the present disclosure.

FIG. 7 illustrates a method for analyzing a population of samples, according to an embodiment of the present disclosure.

FIG. 8 illustrates a method for forming a consolidated array of Taylor cone emitter devices while analyzing a population of samples, according to an embodiment of the present disclosure

Wherever possible, the same reference numbers will be used throughout the drawings to represent the same parts.

### DETAILED DESCRIPTION OF THE INVENTION

In comparison to repositories, systems, and methods lacking at least one of the features described herein, the repositories, systems, and methods of the present embodiments decrease sample processing and analysis time, increase testing throughput, promote simultaneous processing of multiple samples, increase screening efficiency, increase consolidation of screened samples, increase space efficiency; or combinations thereof.

As used herein, “about” indicates a variance of #15% of the value being modified by “about,” unless otherwise indicated to the contrary.

As used herein, “Taylor cone emitter” includes, but is not limited to, an article capable of forming a Taylor cone, including, but not limited to, a solid phase microextraction device or a CBS device. A Taylor cone emitter device may have, but need not have, a sharp edge or a pointed tip. A solid phase microextraction device is a form of a Taylor cone emitter device, but not all Taylor cone emitter devices are solid phase microextraction devices.

As used herein, “solid phase microextraction” includes, but is not limited to, a solid substrate coated with a polymeric sorbent coating, wherein the coating may include metallic particles, silica-based particles, metal-polymeric particles, polymeric particles, or combinations thereof which are physically or chemically attached to the substrate. In some non-limiting examples, the solid substrate has at least one depression disposed in or protrusion disposed on a surface of the substrate and said substrate includes at least one polymeric sorbent coating disposed in or on the at least one depression or protrusion. The term “solid phase microextraction” further includes a solid substrate with at least one indentation or protrusion that contains at least one magnetic component for the collection of magnetic particles or magnetic molecules onto the solid substrate.

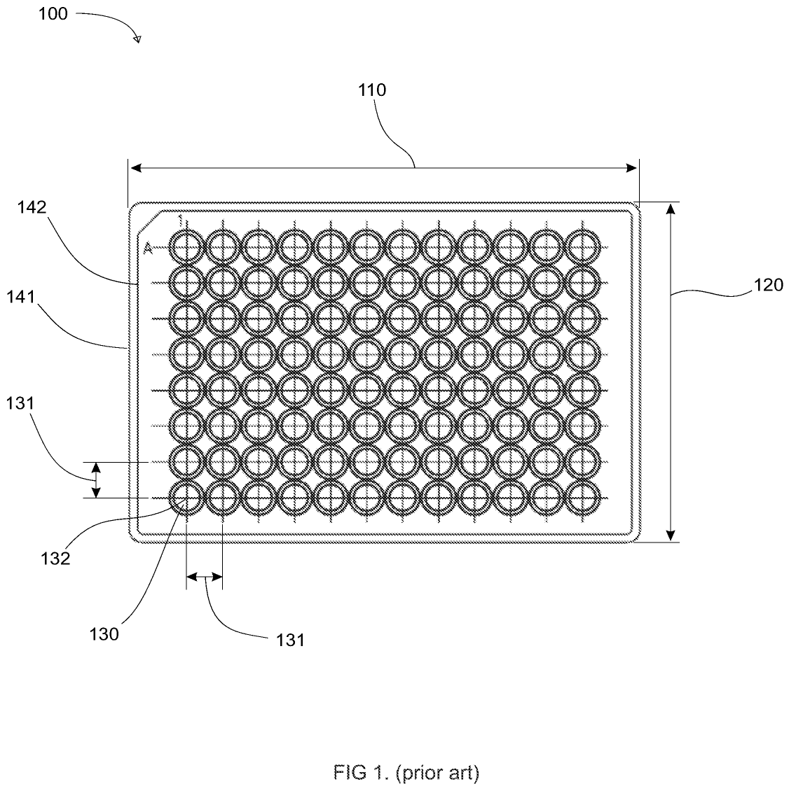

FIG. 1 illustrates an industry standard commercially available microtiter array tray 100 having ninety-six (96) wells 130. The microtiter array tray 100 has standardized values for tray length 110 and tray width 120, establishing the tray footprint of tray skirt 141. Microtiter array trays 100 may optionally have a tray wall 142 recessed from the tray skirt 141. Positions of the wells 130 are denoted by the well centers 132 and the center-to-center position of two adjacent wells 131.

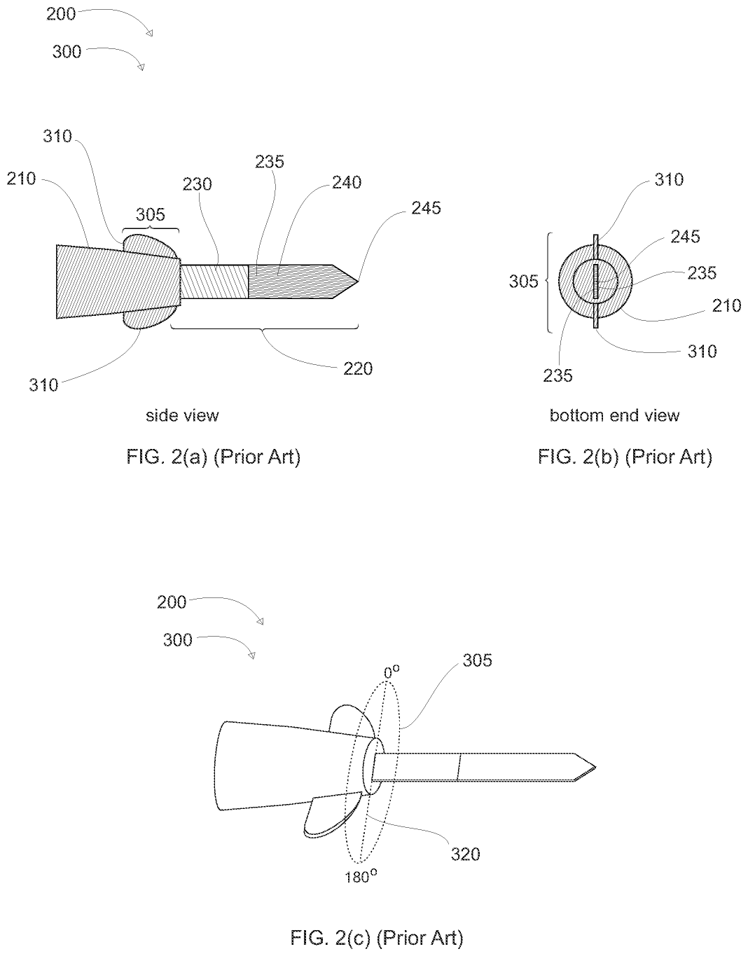

Referring to FIGS. 2(a)-(c), wherein a Taylor cone emitter device 200 is a solid phase microextraction device, the basic elements of the Taylor cone emitter device 200 comprise a substrate 230 having at least one planar surface 235, a sorbent layer 240 disposed on at least a portion of the at least one planar surface 235, a tapering tip 245 extending from the substrate 230 toward an analysis end of the device 200, and a receptacle mount 210 configured for removable attachment to an emplacement of a receiving device. The substrate 230 may have any suitable dimensions, including, but not limited to, about 4 mm wide×about 40 mm long×about 0.5 mm thick. The substrate 230 may be made from any suitable material, including, but not limited to, conductive materials such as, but not limited to, stainless steels. The sorbent layer 240 may include an extraction phase sorbent including, but not limited to, polymeric particles (e.g., silica modified with Cis groups) and a binder (e.g., polyacrylonitrile).

In one embodiment, the Taylor cone emitter device 200 is a CBS device 300 that has been adapted to standard pipette tip dimensions. The blade portion 220 is fitted with a cup as the receptacle mount 210 which is configured to attach to the emplacement 104 on the pipettor end 109. The receptacle mount 210 is fixed to the substrate 230 and is positioned at the opposite end from the sorbent layer 240 and tapering tip 245. The inner surface of the receptacle mount 210 is shaped to employ a friction fit mechanism, consistent with the standard commercial pipette tip cup. Alternatively or in addition to a friction fit mechanism, any suitable mechanism for mounting the receptable mount 210 to the emplacement 104 may be employed, including, but not limited to, a magnetic connector, an expandable compressed o-ring, or combinations thereof. The receptacle mount 210 may be made from electrically insulating polymers consistent with standard pipette tips, such as, but not limited to, polypropylene or electrically conductive polymers such as, but not limited to, carbon impregnated polypropylene.

In one embodiment, the Taylor cone emitter device 200 includes a clocking feature 305, which is configured to fix a radial orientation of the planar surface 235 with respect to the receiving device. “Clocking” is intended to connotate the passage of a hand around an analogue clockface as a paradigm for indicating radial orientation of the planar surface 235. In one embodiment, the clocking feature 305 includes at least one of an indentation or a protrusion corresponding to at least one of a complimentary protrusion or complimentary indentation of the receiving device, such that when the Taylor cone emitter device 200 is mounted to the receiving device, the clocking feature 305 limits the radial orientation of the Taylor cone emitter device 200 with respect to the receiving device to a predetermined number of radial positions. The predetermined number of radial positions may consist of a single radial position, two radial positions, or may include any suitable lager number of radial positions. The Taylor cone emitter device 200 may include visual indicia of the radial orientation of the at least one planar surface 235 on the receptacle mount 210. Such visual indicia may serve to indicate the radial orientation of the at least one planar surface 235 when the planar surface 235 itself is not visible.

In one embodiment, the Taylor cone emitter device 200 is a pipettor-compatible CBS device 300, the receptacle mount 210 is a pipette-tip receptacle mount 210, and the emplacement 104 is a pipettor tip emplacement 104 configured to removably engage the pipette tip receptable mount 210. As used herein, “removable” indicates configuration for removal without damage. The receiving device may be any suitable device, including, but not limited to, a pipettor or a Taylor cone emitter device manipulator.

In one embodiment, the receptacle mount 210 has two fin protrusions 310 extending equidistant from the receptacle mount 210 serving as the clocking feature 305. The presence of the two fin protrusions 310 in this configuration reduces the radial position conditions 320 of the blade to two discreet equivalent positions (i.e., 0° and 180°). The two-fin design depicted here is for illustration purposes; other configurations employing greater or fewer fins may be used, or other features on the receptacle mount 210 may be conceived where the radial rotation of the Taylor cone emitter device 200 is restricted when engaged with an emplacement. In order for the fin protrusions 310 to control radial position, they engage with the receiving device in a lock-and-key arrangement.

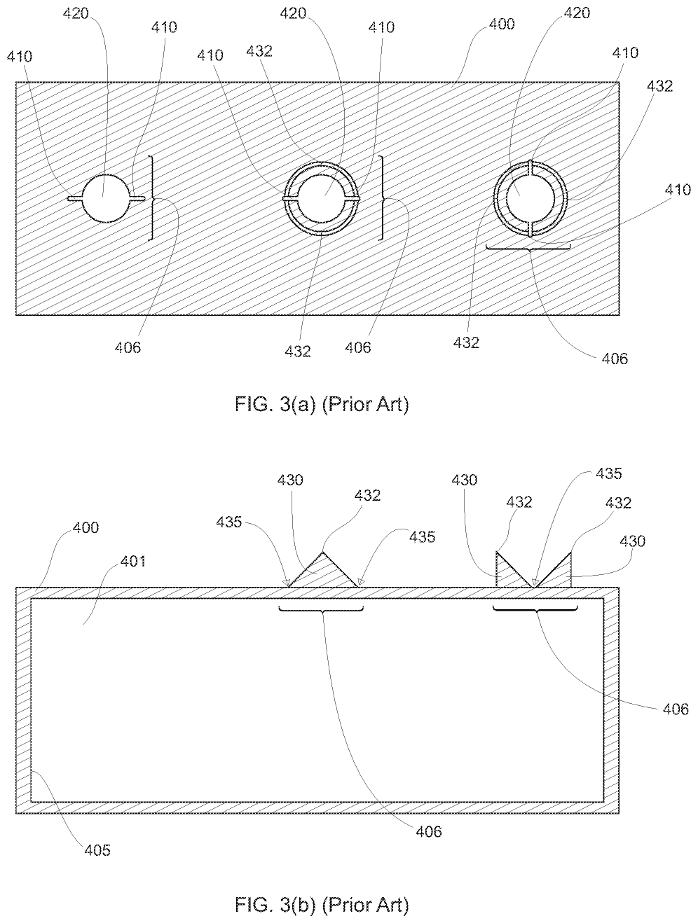

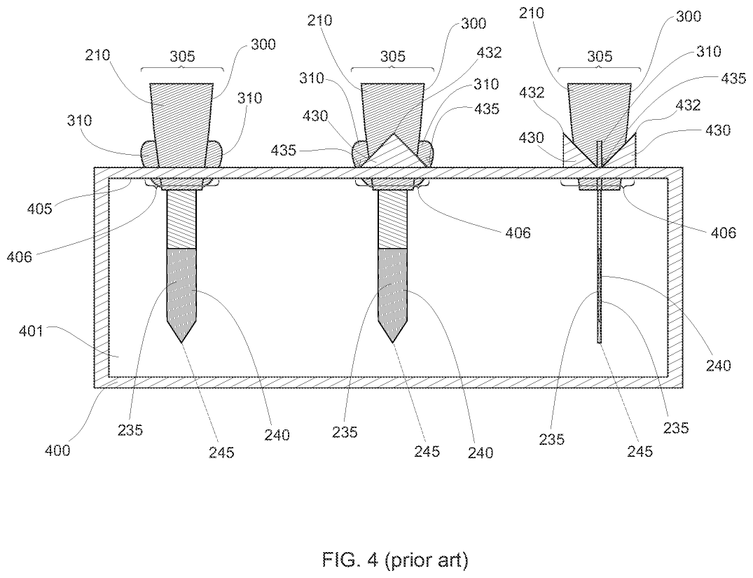

FIGS. 3(a), 3(b), and 4 illustrate a prior Taylor cone emitter device repository 400 which orients the Taylor cone emitter device 200 while it is docked. The Taylor cone emitter device repository 400 includes a repository wall 405 surrounding and defining a chamber 401, a plurality of orifices 420 disposed in the repository wall 405, each configured to receive and retain a substrate 230 and a receptacle mount 210 of a Taylor cone emitter device 200, and a plurality of clocking feature interfaces 406 disposed in the repository wall 405, each configured to guide a clocking feature 305 of the Taylor cone emitter device 200 into a predetermined radial orientation and fix the Taylor cone emitter device 200 in the predetermined radial orientation. The chamber 401 is configured to accept the substrate 230 of the Taylor cone emitter device 200 with the substrate 230 and a tapering tip 245 extending from the substrate 230 being remote from contact with the repository wall 405 or any adjacent Taylor cone emitter devices 200 disposed in the Taylor cone emitter device repository 400.

As depicted, the Taylor cone emitter device repository 400 includes two slits 410 as the clocking feature interfaces 406, radially positioned consistent with clocking feature 305 of the CBS device 300. As depicted, the taper of the blade fins 310 provides an additional mechanism to assist the successful docking of slightly offset CBS devices 300 with respect to the axial center of the tapering tip 245 and the orifices 420 of the Taylor cone emitter device repository 400. As depicted, the clocking feature interface 406 includes guidance protrusions 430 surrounding the orifice 420 to promote proper alignment of CBS 300 when they are docked into the Taylor cone emitter device repository 400. If the CBS device 300 is radially off axis with respect to the orientation of the clocking feature 305 to the clocking feature interface 406, the guidance protrusions 430 are tapered to a point 432 and join to create a valley shape 435 at the base of the orifice 420. The taper of the guidance protrusions 430 provides a mechanism to guide and realign an off-axis CBS device 300 so that it is properly positioned while docked in the Taylor cone emitter device repository 400.

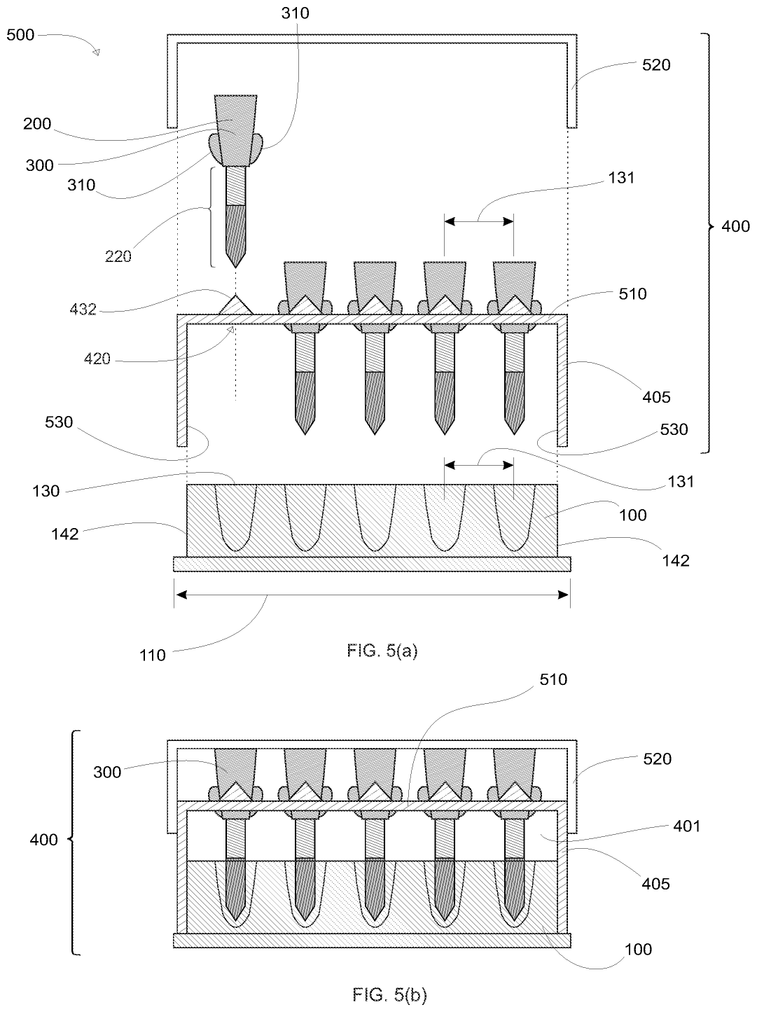

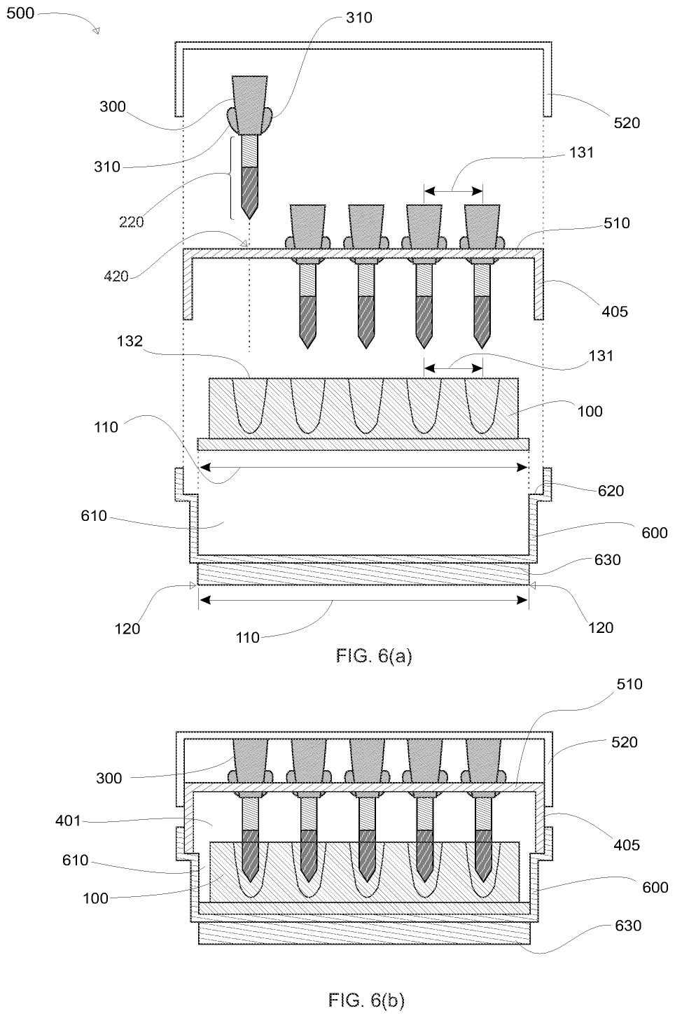

Referring to FIGS. 5(a), 5(b), 6(a), and 6(b), in one embodiment, a Taylor cone emitter device repository system 500 includes a microtiter array tray 100 having an array of wells 130, an array of Taylor cone emitter devices 200, and a Taylor cone emitter device repository 400. The Taylor cone emitter device repository 400 includes a repository plate 510, a repository wall 405 extending from the repository plate 510 and peripherally surrounding a substrate chamber 401, and array of orifices 420 disposed in the repository plate 510, and an array of array of clocking features interfaces 406 disposed in the repository plate 510. Each of the array of orifices 420 is configured to receive and retain the substrate 230 and the receptacle mount 210 of one of the array of Taylor cone emitter devices 200. The array of clocking features interfaces 406 is configured to guide clocking features 305 of each of the array of Taylor cone emitter devices 200 into predetermined radial orientations such that the array of clocking feature interfaces 406 fixes each of the array of Taylor cone emitter devices 200 in the predetermined radial orientations. The substrate chamber 401 is configured to at least partially receive the microtiter array tray 100 and to accept the substrate 230 of each of the array of Taylor cone emitter devices 200 with the substrate 230 and the tapering tip 245 being remote from contact with the repository wall 405 or any adjacent of the array of Taylor cone emitter devices 200 disposed in the Taylor cone emitter device repository 400. The array of orifices 420 disposed in the repository plate 510 is distributed in alignment with the microtiter array tray 100 such that each of the array of Taylor cone emitter devices 200, when the microtiter array tray 100 is at least partially received by the substrate chamber 401, is disposed within a separate well 130 of the array of wells 130. The Taylor cone emitter devices 200 may be CBS devices 300. The receptacle mount 210 may be a pipette-tip receptacle mount 210.

In one embodiment, the microtiter array tray 100 and the Taylor cone emitter device repository 400, as assembled, have a combined footprint equal to that of the microtiter array tray 100 alone.

In one embodiment, the Taylor cone emitter device repository system 500 includes a repository cover 520 configured to mount over the repository plate 510 so as to secure the array of Taylor cone emitter devices 200 within the array of orifices 420.

Referring to FIGS. 5(a) and 5(b), in one embodiment, the repository wall 405 is configured to fit over the microtiter array tray 100 in peripheral contact, via an internal surface 530 of the repository wall 405, with a peripheral surface 142 of the microtiter array tray.

Referring to FIGS. 6(a) and 6(b), in another embodiment, the Taylor cone emitter device repository 400 further includes a repository base 600 having a cavity 610 configured to receive the microtiter array tray 100, wherein the repository wall 405 is configured to engage with the repository base 600, defining the substrate chamber 401 in conjunction with the repository plate 510, with the microtiter array tray 100 being disposed entirely within the substrate chamber 401. In a further embodiment, repository base 600 includes a repository shelf 620 upon which the repository wall 405 sits, as well as a repository base footing 630 which extends below the repository base 600 and which has the same footprint as the microtiter array tray 100.

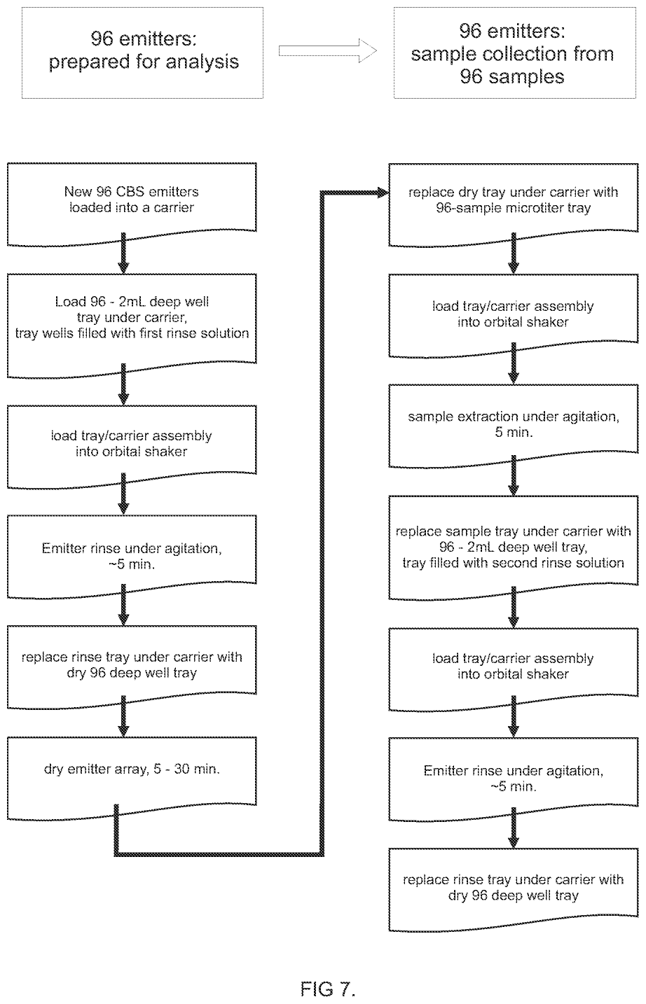

Referring to FIG. 7, in one embodiment, a method for analyzing a population of samples includes disposing a plurality of sample-exposed Taylor cone emitter devices 200 in a Taylor cone emitter device repository 400 as an array of Taylor cone emitter devices 200, at least partially disposing a first microtiter array tray 100 in the substrate chamber 401, and preparing the array of Taylor cone emitter devices 200 for analysis in the Taylor cone emitter device repository 400. Each of the array of Taylor cone emitter devices 200 is withdrawn from the Taylor cone emitter device repository 400 and analyzed by a first analytical method to screen for a predetermined sample characteristic. Then the array of Taylor cone emitter devices 200 is sorted based on the predetermined sample characteristic, and the array of Taylor cone emitter devices 200 is consolidated down to a consolidated array excluding those Taylor cone emitter devices 200 lacking the predetermined sample characteristic. A second analytical method is performed on the consolidated array of Taylor cone emitter devices 200.

The first analytical method may be any suitable method, including, but not limited to, mass spectrometry via direct interface. The second analytical method may be any suitable method, including, but not limited to, liquid chromatography, hybrid chromatography-mass spectrometry, capillary electrophoresis, mass spectrometry-based immunoassays, or combinations thereof.

Preparing the array of Taylor cone emitter devices 200 for analysis may include disposing a first rinse solution in the array of wells 130 of the first microtiter array tray 100, partially immersing the array of Taylor cone emitter devices 200 in the first rinse solution, and removing the first microtiter array tray 100. The first rinse solution may be any suitable solution, including but not limited to an aqueous or non-aqueous solution suitable for clearing a Taylor cone emitter prior to immersion in a sample. The Taylor cone emitter device repository 400 may be agitated while the array of Taylor cone emitter devices 200 is partially immersed in the first rinse solution. Following removing the first microtiter array tray 100 from the Taylor cone emitter device repository 400, the array of Taylor cone emitter devices 200 may be dried. Following removing the first microtiter array tray 100, the first microtiter array tray 100 may be replaced in the Taylor cone emitter device repository 400 with a second microtiter array tray 100. Following removing the first microtiter array tray 100 and prior to analyzing each of the array of Taylor cone emitter devices 200, the first microtiter array tray 100 may be replaced in the Taylor cone emitter device repository 400 with a second microtiter array 100 tray having an extraction solution in the array of wells 130 and the Taylor cone emitter device repository 400 may be agitated. Following analyzing each of the array of Taylor cone emitter devices 200 with the first analytical method, the second microtiter array tray 100 may be replaced with a third microtiter array tray 100 having a second rinse solution in the array of wells, and the array of Taylor cone emitter devices 200 may be partially immersed in the second rinse solution, and, optionally, agitated. The second rinse solution may be any suitable solution, including but not limited to an aqueous or non-aqueous solution suitable for clearing a Taylor cone emitter after immersion in a sample.

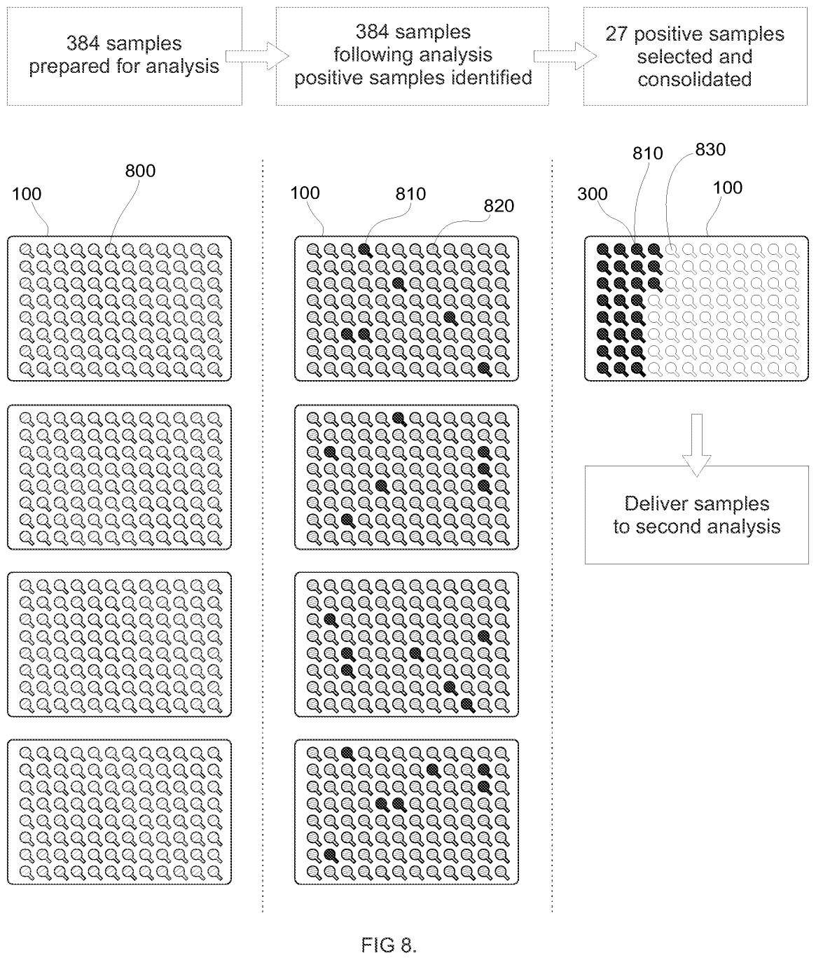

Referring to FIG. 8, by the method shown in FIG. 7, multiple microtiter array trays 100 may be screened to differentiate positive sample 810 and negative samples 820 from unexamined samples 800, and then the positive samples 810 may be consolidated to a microtiter array tray 100 and any remaining wells 130 may be left empty 830.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A Taylor cone emitter device repository, comprising:
a repository plate;
a repository wall extending from the repository plate and peripherally surrounding a substrate chamber;
an array of orifices disposed in the repository plate, each configured to receive and retain a substrate and a receptacle mount of one of an array of Taylor cone emitter devices; and
an array of clocking feature interfaces disposed in the repository plate configured to guide clocking features of each of the array of Taylor cone emitter devices into predetermined radial orientations such that the array of clocking feature interfaces fixes each of the array of Taylor cone emitter devices in the predetermined radial orientations,
wherein:
the substrate chamber is configured to at least partially receive a microtiter array tray and to accept the substrate of each of the array of Taylor cone emitter devices with the substrate and a tapering tip extending from the substrate being remote from contact with the repository wall or any adjacent of the array of Taylor cone emitter devices disposed in the Taylor cone emitter device repository; and
the array of orifices disposed in the repository plate is distributed in alignment with the microtiter array tray such that each of the array of Taylor cone emitter devices, when the microtiter array tray is at least partially received by the substrate chamber, is disposed within a separate well of the microtiter array tray.

2. The Taylor cone emitter device repository of claim 1, wherein the array of orifices includes 48 orifices in a 6×8 matrix.

3. The Taylor cone emitter device repository of claim 1, wherein the array of orifices includes 96 orifices in an 8×12 matrix.

4. The Taylor cone emitter device repository of claim 1, wherein the repository wall is configured to fit over the microtiter array tray in peripheral contact with a peripheral surface of the microtiter array tray.

5. The Taylor cone emitter device repository of claim 1, further including a repository base having a cavity configured to receive the microtiter array tray, wherein the repository wall is configured to engage with the repository base, defining the substrate chamber in conjunction with the repository plate, with the microtiter array tray being disposed entirely within the substrate chamber.

6. The Taylor cone emitter device repository of claim 1, further including a repository cover, wherein the repository cover is configured to mount over the repository plate so as to secure the array of Taylor cone emitter devices within the array of orifices

7. The Taylor cone emitter device repository of claim 1, wherein the Taylor cone emitter device is a coated blade spray device.

8. The Taylor cone emitter device repository of claim 1, wherein the receptacle mount is a pipette tip receptacle mount.

9. A Taylor cone emitter device repository system, comprising:
a microtiter array tray having an array of wells;
an array of Taylor cone emitter devices, each of the array of Taylor cone emitter devices including;
a substrate having at least one planar surface;
a sorbent layer disposed on at least a portion of the at least one planar surface;
a tapering tip extending from the substrate;
a receptacle mount configured for removable attachment to an emplacement of a receiving device; and
a clocking feature configured for fixing a radial orientation of the planar surface with respect to the receiving device; and
a Taylor cone emitter device repository, including:
a repository plate;
a repository wall extending from the repository plate and peripherally surrounding a substrate chamber;
an array of orifices disposed in the repository plate, each configured to receive and retain the substrate and the receptacle mount of one of the array of Taylor cone emitter devices; and
an array of clocking feature interfaces disposed in the repository plate configured to guide clocking features of each of the array of Taylor cone emitter devices into predetermined radial orientations such that the array of clocking feature interfaces fixes each of the array of Taylor cone emitter devices in the predetermined radial orientations,
wherein:
the substrate chamber is configured to at least partially receive the microtiter array tray and to accept the substrate of each of the array of Taylor cone emitter devices with the substrate and the tapering tip being remote from contact with the repository wall or any adjacent of the array of Taylor cone emitter devices disposed in the Taylor cone emitter device repository; and
the array of orifices disposed in the repository plate is distributed in alignment with the microtiter array tray such that each of the array of Taylor cone emitter devices, when the microtiter array tray is at least partially received by the substrate chamber, is disposed within a separate well of the array of wells.

10. The Taylor cone emitter device repository system of claim 9, wherein the microtiter array tray and the Taylor cone emitter device repository, as assembled, have a combined footprint equal to that of the microtiter array tray alone.

11. A method for analyzing a population of samples, comprising:
disposing a plurality of sample-exposed Taylor cone emitter devices in a Taylor cone emitter device repository as an array of Taylor cone emitter devices:
each of the array of Taylor cone emitter devices including;
a substrate having at least one planar surface;
a sorbent layer disposed on at least a portion of the at least one planar surface;
a tapering tip extending from the substrate;
a receptacle mount configured for removable attachment to an emplacement of a receiving device; and
a clocking feature configured for fixing a radial orientation of the planar surface with respect to the receiving device; and
the Taylor cone emitter device repository including:
a repository plate;
a repository wall extending from the repository plate and peripherally surrounding a substrate chamber;
an array of orifices disposed in the repository plate, each configured to receive and retain a substrate and a receptacle mount of one of an array of Taylor cone emitter devices; and
an array of clocking feature interfaces disposed in the repository plate configured to guide clocking features of each of the array of Taylor cone emitter devices into predetermined radial orientations such that the array of clocking feature interfaces fixes each of the array of Taylor cone emitter devices in the predetermined radial orientations;
wherein:
the substrate chamber is configured to at least partially receive a microtiter array tray and to accept the substrate of each of the array of Taylor cone emitter devices with the substrate and a tapering tip extending from the substrate being remote from contact with the repository wall or any adjacent of the array of Taylor cone emitter devices disposed in the Taylor cone emitter device repository; and
the array of orifices disposed in the repository plate is distributed in alignment with the microtiter array tray such that each of the array of Taylor cone emitter devices, when the microtiter array tray is at least partially received by the substrate chamber, is disposed within a separate well of an array of wells of the microtiter array tray;
at least partially disposing a first microtiter array tray in the substrate chamber;
preparing the array of Taylor cone emitter devices for analysis in the Taylor cone emitter device repository;
withdrawing each of the array of Taylor cone emitter devices from the Taylor cone emitter device repository and analyzing each the array of Taylor cone emitter devices by a first analytical method to screen for a predetermined sample characteristic;
sorting the array of Taylor cone emitter devices based on the predetermined sample characteristic, forming a consolidated array of Taylor cone emitter devices; and
performing a second analytical method on the consolidated array of Taylor cone emitter devices.

12. The method of claim 11, wherein the Taylor cone emitter device repository further includes a repository cover configured to mount over the repository plate so as to secure the array of Taylor cone emitter devices within the array of orifices

13. The method of claim 11, wherein the first analytical method is mass spectrometry via direct interface.

14. The method of claim 11, wherein the second analytical method is selected from the group consisting of liquid chromatography, hybrid chromatography-mass spectrometry, capillary electrophoresis, mass spectrometry-based immunoassays, and combinations thereof.

15. The method of claim 11, wherein preparing the array of Taylor cone emitter devices for analysis includes disposing a first rinse solution in the array of wells of the first microtiter array tray, partially immersing the array of Taylor cone emitter devices in the first rinse solution, and removing the first microtiter array tray.

16. The method of claim 15, wherein the Taylor cone emitter device repository is agitated while the array of Taylor cone emitter devices is partially immersed in the first rinse solution.

17. The method of claim 15, wherein following removing the first microtiter array tray, the array of Taylor cone emitter devices is dried.

18. The method of claim 15, wherein following removing the first microtiter array tray, the first microtiter array tray is replaced in the Taylor cone emitter device repository with a second microtiter array tray.

19. The method of claim 15, wherein following removing the first microtiter array tray and prior to analyzing each of the array of Taylor cone emitter devices, the first microtiter array tray is replaced in the Taylor cone emitter device repository with a second microtiter array tray having an extraction solution in the array of wells and the Taylor cone emitter device repository is agitated.

20. The method of claim 19, wherein following analyzing each of the array of Taylor cone emitter devices with the first analytical method, the second microtiter array tray is replaced with a third microtiter array tray having a second rinse solution in the array of wells, and the array of Taylor cone emitter devices is partially immersed in the second rinse solution.
